(19) United States
(12) Patent Application Publication
(10) Pub. No.: US 2026/0025468 A1
(43) Pub. Date: Jan. 22, 2026

(54) METHOD AND SYSTEM FOR SERVICE TYPE-BASED POLICY COUNTER SERVICE

(71) Applicant: Verizon Patent and Licensing Inc., Basking Ridge, NJ (US)

(72) Inventors: Lixia Yan, Basking Ridge, NJ (US); Violeta Cakulev, Millburn, NJ (US); Harinder S. Lakhian, Plano, TX (US); Ali Imdad Malik, East Brunswick, NJ (US)

(21) Appl. No.: 18/773,824

(22) Filed: Jul. 16, 2024

(51) Int. Cl. H04M 15/00; H04W 4/24

(52) U.S. Cl. CPC H04M 15/887; H04W 4/24

(57) ABSTRACT

A method, an end device, and a non-transitory computer-readable storage medium are described in relation to a service type-based policy counter service. The service type-based policy counter service may provide a policy counter type that indicates a category for a set of policy counters. A network device may use the policy counter type in a message to subscribe to a spending limit control service of a charging device, such as a charging function. The charging device may provide policy counter status information for the policy counters indicated by the policy counter type.

### BACKGROUND

A network may include a network device that manages charging, such as online and offline charging, of subscriber spending.

### BRIEF DESCRIPTION OF THE DRAWINGS

FIG. 1 is a diagram illustrating an exemplary environment in which an exemplary embodiment of a service type-based policy counter service may be implemented;

FIG. 2A is a messaging diagram illustrating an exemplary process of an exemplary embodiment of the service type-based policy counter service according to an exemplary scenario;

FIG. 2B is a diagram illustrating an exemplary embodiment of policy counter information;

FIG. 3 is a diagram illustrating exemplary components of a device that may correspond to one or more of the devices illustrated and described herein;

FIG. 4 is a flow diagram illustrating an exemplary process of an exemplary embodiment of the service type-based policy counter service; and

FIG. 5 is a flow diagram illustrating another exemplary process of an exemplary embodiment of the service type-based policy counter service.

### DETAILED DESCRIPTION

The following detailed description refers to the accompanying drawings. The same reference numbers in different drawings may identify the same or similar elements. Also, the following detailed description does not limit the invention.

In a Fifth Generation (5G) core network, a charging function (CHF) may provide a spending limit control service. For example, the CHF may maintain policy counters that track spending of network resources associated with an end device (e.g., user equipment (UE)) and/or a user. The CHF may enable a network function (NF) service consumer, such as a policy control function (PCF), an access and mobility management function (AMF), or another type of NF service consumer, to retrieve policy counter status information and spending limit reporting associated with the end device and/or the user (end device/user). For example, the CHF may maintain a charging profile for each end device/user. The CHF may send charging information via policy counters to the NF service consumer.

The NF service consumer may establish a subscription with the CHF based on a sending a subscription message to the CHF. Currently, however, for the same end device/user, the CHF may receive multiple subscription messages from multiple NF service consumers. The CHF does not know the type of NF service consumer and may return all the policy counters defined at the subscriber level to the NF service consumers. In this regard, an NF service consumer may receive one or multiple policy counters that may not be relevant to the NF service consumer. For example, some policy counters may relate to or be defined for session management while other policy counters may relate to or be defined for access and mobility management. As a result, the spending limit control service wastes network transport resources based on the sending of policy counters that may not be relevant to the NF service consumer.

According to exemplary embodiments, a service type-based policy counter service is described. According to an exemplary embodiment, the service type-based policy counter service may include implementation by an NF service consumer. For example, the NF service consumer may be implemented as a core network device, such as a policy control device. For example, the policy control device may be implemented as a PCF, a split PCF (e.g., an access and mobility management (AM)-PCF, a UE-PCF, a session management (SM)-PCF, or the like), a similar type of future generation policy control device or function, a legacy policy control device or function (e.g., a policy control rules function (PCRF)), or a converged or multi-generational policy control device (e.g., PCF+PCRF, PCF+future generation PCF, etc.). According to other examples, the NF service consumer or NF client may be implemented by a network device other than a policy control device, such as an AMF, a network exposure function (NEF), or another type of network device (e.g., core network device) that be configured to utilize the spending limit control service.

According to an exemplary embodiment, the service type-based policy counter service may include implementation by a charging device. For example, the charging device may be implemented as a CHF, a future generation CHF, or a similar functioning network device of a charging system, a converged charging system, or the like.

According to an exemplary embodiment, the service type-based policy counter service may include an information element (IE) or another form of data instance that indicates a type of policy counter that the NF service consumer or NF client wishes to obtain. For example, the NF service consumer may include a policy counter type IE in a subscription request to the CHF. According to an exemplary embodiment, the policy counter type IE or another form of data instance may indicate one or multiple types of policy counters, as described herein.

According to an exemplary embodiment, the service type-based policy counter service may enable the charging device, such as the CHF, to read the policy counter type IE or another form of data instance and return only the types of policy counters indicated. According to an exemplary embodiment, the CHF may store information that correlates a policy counter to its corresponding policy counter type. For example, a policy counter (P1) may be correlated to a policy counter type (SM).

According to an exemplary embodiment, the service type-based policy counter service may be implemented for home-routed roaming and non-roaming scenarios.

In view of the foregoing, the service type-based policy counter service may improve network resource utilization, network operability, network performance, and other aspects of network-side and end device-side wireless services.

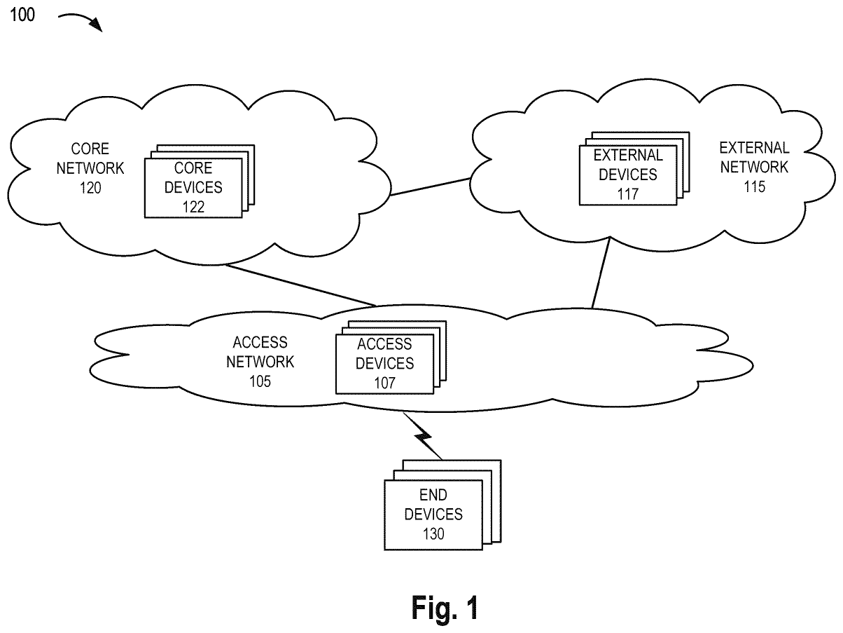

FIG. 1 is a diagram illustrating an exemplary environment 100 in which an exemplary embodiment of the service type-based policy counter service may be implemented. As illustrated, environment 100 includes an access network 105, an external network 115, and a core network 120. Access network 105 includes access devices 107 (also referred to individually or generally as access device 107). External network 115 includes external devices 117 (also referred to individually or generally as external device 117). Core network 120 includes core devices 122 (also referred to individually or generally as core device 122). Environment 100 further includes end devices 130 (also referred to individually and generally as end device 130).

The number, type, and arrangement of networks illustrated in environment 100 are exemplary. For example, according to other exemplary embodiments, environment 100 may include fewer networks, additional networks, and/or different networks. For example, according to other exemplary embodiments, other networks not illustrated in FIG. 1 may be included, such as an X-haul network (e.g., backhaul, mid-haul, fronthaul, etc.), a transport network, or another type of network that may support a wireless service and/or an end device application service, as described herein.

A network device, a network element, or a network function (referred to herein simply as a network device) may be implemented according to one or multiple network architectures, such as a client device, a server device, a peer device, a proxy device, a cloud device, and/or a virtualized network device. Additionally, a network device may be implemented according to various computing architectures, such as centralized, distributed, cloud (e.g., elastic, public, private, etc.), edge, fog, and/or another type of computing architecture, and may be incorporated into distinct types of network architectures (e.g., Software Defined Networking (SDN), client/server, peer-to-peer, etc.) and/or implemented with various networking approaches (e.g., logical, virtualization, network slicing, etc.). The number, the type, and the arrangement of network devices are exemplary.

Environment 100 includes communication links between the networks and between the network devices. Environment 100 may be implemented to include wired, optical, and/or wireless communication links. A communicative connection via a communication link may be direct or indirect. For example, an indirect communicative connection may involve an intermediary device and/or an intermediary network not illustrated in FIG. 1. A direct communicative connection may not involve an intermediary device and/or an intermediary network. The number, type, and arrangement of communication links illustrated in environment 100 are exemplary.

Environment 100 may include various planes of communication including, for example, a control plane, a user plane, a service plane, and/or a network management plane. Environment 100 may include other types of planes of communication. A message communicated in support of the service type-based policy counter service may use at least one of these planes of communication.

An interface of a network device may be modified (e.g., relative to an interface defined by a standards body, such as Third Generation Partnership Project (3GPP), 3GPP2, International Telecommunication Union (ITU), European Telecommunications Standards Institute (ETSI), GSM Association (GSMA), etc.) or a new interface of the network device may be provided in order to support the communication (e.g., transmission and reception of messages, IEs, attribute value pairs (AVPs), etc.) between network devices and the service type-based policy counter service logic of the network device, as described herein. According to various exemplary implementations, the interface of the network device may be a service-based interface, a reference point-based interface, an Open Radio Access Network (O-RAN) interface, or some other type of interface.

Access network 105 may include one or multiple networks of one or multiple types and technologies. For example, access network 105 may be implemented to include a Fifth Generation (5G) RAN, a future generation RAN (e.g., a Sixth Generation (6G) RAN, a Seventh Generation (7G) RAN, or a subsequent generation RAN), a centralized-RAN (C-RAN), an Open-RAN (O-RAN), and/or another type of access network. Access network 105 may include a legacy RAN (e.g., a Third Generation (3G) RAN, a Fourth Generation (4G) RAN, etc.). Access network 105 may communicate with and/or include other types of access networks, such as, for example, a Wi-Fi network, a local area network (LAN), a Citizens Broadband Radio System (CBRS) network, a cloud RAN, a virtualized RAN (vRAN), a self-organizing network (SON), a wired network (e.g., optical, cable, etc.), or another type of network that provides access to or can be used as an on-ramp to access network 105.

Depending on the implementation, access network 105 may include one or multiple types of network devices, such as access devices 107. For example, access device 107 may include a next generation Node B (gNB), an enhanced LTE (eLTE) evolved Node B (eNB), an eNB, a radio network controller (RNC), a radio intelligent controller (RIC), a base station controller (BSC), a remote radio head (RRH), a baseband unit (BBU), a radio unit (RU), a remote radio unit (RRU), a centralized unit (CU), a CU-control plane (CP), a CU-user plane (UP), a distributed unit (DU), a small cell node (e.g., a picocell device, a femtocell device, a microcell device, a home eNB, a home gNB, etc.), an open network device (e.g., O-RAN Centralized Unit (O-CU), O-RAN Distributed Unit (O-DU), O-RAN next generation Node B (O-gNB), O-RAN evolved Node B (O-eNB)), a 5G ultra-wide band (UWB) node, a future generation wireless access device (e.g., a 6G wireless station, a 7G wireless station, or another generation of wireless station), or another type of wireless node (e.g., a WiFi device, a WiMax device, a hotspot device, a fixed wireless access CPE (FWA CPE), etc.) that provides a wireless access service. Additionally, access devices 107 may include a wired and/or an optical device (e.g., modem, wired access point, optical access point, Ethernet device, multiplexer, etc.) that provides network access and/or transport service.

External network 115 may include one or multiple networks of one or multiple types and technologies that provide an end device application service. For example, external network 115 may be implemented using one or multiple technologies including network function virtualization (NFV), SDN, cloud computing, Infrastructure-as-a-Service (IaaS), Platform-as-a-Service (PaaS), Software-as-a-Service (SaaS), or another type of network technology. External network 115 may be implemented to include a cloud network, a private network, a public network, a multi-access edge computing (MEC) network, a fog network, the Internet, a packet data network (PDN), a service provider network, the World Wide Web (WWW), an Internet Protocol Multimedia Subsystem (IMS) network, a Rich Communication Service (RCS) network, a virtual network, a packet-switched network, a data center, a data network, or other type of application service layer network that may provide access to and may host an end device application service.

External devices 117 may host one or multiple types of end device application services. For example, the end device application service may pertain to broadband services in dense areas (e.g., pervasive video, smart office, operator cloud services, video/photo sharing, etc.), broadband access everywhere (e.g., 50/100 Mbps, ultra-low-cost network, etc.), enhanced mobile broadband (eMBB), higher user mobility (e.g., high speed train, remote computing, moving hot spots, etc.), Internet of Things (IoT) (e.g., smart wearables, sensors, mobile video surveillance, smart cities, connected home, etc.), extreme real-time communications (e.g., tactile Internet, augmented reality (AR), virtual reality (VR), etc.), lifeline communications (e.g., natural disaster, emergency response, etc.), ultra-reliable communications (e.g., automated traffic control and driving, collaborative robots, health-related services (e.g., monitoring, remote surgery, etc.), drone delivery, public safety, etc.), broadcast-like services, communication services (e.g., email, text (e.g., Short Messaging Service (SMS), Multimedia Messaging Service (MMS), etc.), massive machine-type communications (mMTC), voice, video calling, video conferencing, instant messaging), video streaming, fitness services, navigation services, and/or other types of wireless and/or wired application services. External devices 117 may also include other types of network devices that support the operation of external network 115 and the provisioning of application services, such as an orchestrator, an edge manager, an operations support system (OSS), a local domain name system (DNS), registries, and/or external devices 117 that may pertain to various network-related functions (e.g., security, management, charging, billing, authentication, authorization, policy enforcement, development, etc.). External devices 117 may include non-virtual, logical, and/or physical network devices.

Core network 120 may include one or multiple networks of one or multiple network types and technologies. Core network 120 may include a complementary network of access network 105. For example, core network 120 may be implemented to include a 5G core network, an evolved packet core (EPC) network of an LTE network, an LTE-Advanced (LTE-A) network, and/or an LTE-A Pro network, a future generation core network (e.g., a 5G Advanced, a 6G, a 7G, or another generation of core network), and/or another type of core network.

Depending on the implementation of core network 120, core network 120 may include diverse types of network devices that are illustrated in FIG. 1 as core devices 122. For example, core devices 122 may include a user plane function (UPF), a Non-3GPP Interworking Function (N3IWF), an AMF, a session management function (SMF), a unified data management (UDM) device, a unified data repository (UDR), an authentication server function (AUSF), a security anchor function (SEAF), a network exposure function (NEF), a network slice selection function (NSSF), a network repository function (NRF), a PCF, a network data analytics function (NWDAF), a service capability exposure function (SCEF), a lifecycle management (LCM) device, a mobility management entity (MME), a packet data network (PDN) gateway (PGW), an enhanced packet data gateway (ePDG), a serving gateway (SGW), a home agent (HA), a General Packet Radio Service (GPRS) support node (GGSN), a home subscriber server (HSS), an authentication, authorization, and accounting (AAA) server, a PCRF, a policy and charging enforcement function (PCEF), a CHF, a charging system (CS), and/or a future generation core network device that may provide similar functions and/or services as those described herein.

According to other exemplary implementations, core devices 122 may include additional, different, and/or fewer network devices than those described. For example, core devices 122 may include a non-standard or a proprietary network device, and/or another type of network device that may be well-known but not particularly mentioned herein. Core devices 122 may also include a network device that provides a multi-RAT functionality (e.g., 4G and 5G, 5G and 5.5G, 5G and 6G, 6G and 7G, etc.), such as an SMF with PGW control plane functionality (e.g., SMF+PGW-C), a UPF with PGW user plane functionality (e.g., UPF+PGW-U), and/or other combined nodes (e.g., an HSS with a UDM and/or UDR, an MME with an AMF, a converged charging system (CCS), etc.). Also, core devices 122 may include a split core device 122. For example, core devices 122 may include an SM-PCF, an AM-PCF, a UE-PCF, and/or another type of split architecture associated with another core device 122, as described herein.

According to an exemplary embodiment, at least some of core devices 122 may include logic of the service type-based policy counter service. For example, a PCF, a split PCF, another type of policy control device, an AMF, a NEF, and/or other types of NF service consumers that may have an interface to a CHF and access to a spending limit control service, as described herein. According to another example, the CHF or similar type of charging device may include logic of the service type-based policy counter service.

According to an exemplary embodiment, the logic of the service type-based policy counter service at the NF service consumer device may include the generation and transmission of a message that includes the policy counter type data. For example, the AM-PCF (or another type of NF client) may generate a subscription request (e.g., initial or intermediate) pertaining to the spending limit control service that includes an IE that indicates one or multiple policy counter types of relevance. The AM-PCF may transmit the subscription request to the CHF, for example. The AM-PCF may receive a subscription response and/or other types of messages (e.g., a spending limit report, a notification of policy counter status changes, etc.) from the CHF that includes policy counter status information corresponding to the policy counter type(s). According to an exemplary embodiment, the logic of the service type-based policy counter service at the NF service consumer device may include configuration of policy counter information. For example, the policy counter information may include policy counter identifiers that may be correlated to respective policy counter types, as described herein. According to other exemplary embodiments, the policy counter information may include the policy counter types.

According to an exemplary embodiment, the logic of the service type-based policy counter service at the CHF or similar type of charging device may include the creation of the spending limit control service subscription based on the policy counter type data. The logic of the service type-based policy counter service at the CHF or similar type of charging device may include reading and/or interpreting the policy counter type data and selecting the policy counter(s) and associated policy counter status information of relevance to the policy counter type data. For example, the logic of the service type-based policy counter service may include storing policy counter information. The policy counter information may include the policy counter information may include policy counter identifiers that may be correlated to respective policy counter types, as described herein.

Additionally, the logic of the service type-based policy counter service at the CHF or similar type of charging device may include the generation and transmission of a message that includes policy counter status information regarding the policy counter(s) of the policy counter type data.

End device 130 may include a device that may have computational and communication capabilities (e.g., wireless, wired, optical, etc.). End device 130 may be implemented as a mobile device, a portable device, a stationary device (e.g., a non-mobile device and/or a non-portable device), a device operated by a user, or a device not operated by a user. For example, end device 130 may be implemented as a smartphone, a mobile phone, a personal digital assistant, a tablet, a netbook, a wearable device (e.g., a watch, glasses, headgear, a band, etc.), a computer, a gaming device, a television, a set top box, a music device, an IoT device, a drone, or another type of UE.

End device 130 may be configured to execute various types of software (e.g., applications, programs, etc.). The number and the types of software may vary among end devices 130. For example, end device 130 may host one or multiple end device applications that may relate to diverse types of application services described in relation to external devices 117. For example, the end device application may pertain to IoT, extreme real-time communications, gaming, voice, video-calling, navigation, ultra-reliable communications, and so forth. The end device application may include a client-side application.

End device 130 may include “edge-aware” and/or “edge-unaware” application service clients. For purposes of description, end device 130 is not considered a network device. End device 130 may be implemented as a virtualized device in whole or in part.

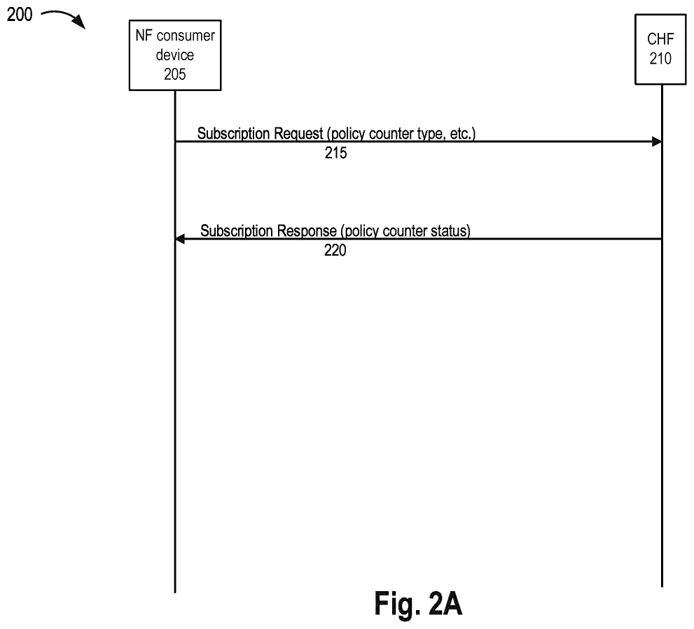

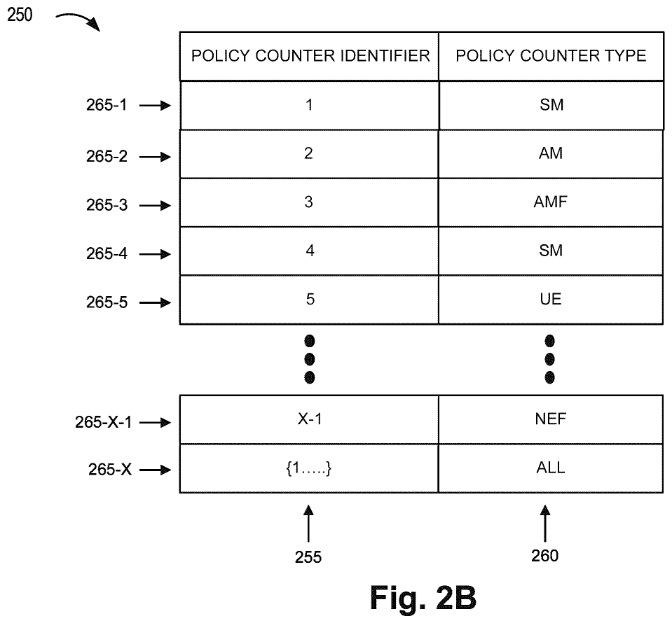

FIG. 2A is a messaging diagram illustrating an exemplary process of an exemplary embodiment of the service type-based policy counter service according to an exemplary scenario and environment. As illustrated, exemplary environment may include an NF consumer device 205 and a CHF 210. The environment depicted in FIG. 2A is exemplary.

NF consumer device 205 may be implemented as a PCF, a split PCF, an AMF, or another core device 122 that may have an interface to a CHF and access to a spending limit control service, as described herein. As such, NF consumer device 205 and CHF 210 may each provide a function and/or a service in accordance with a network standard, such as 3GPP, 3GPP2, ITU, ETSI, GSMA, or the like and/or of a proprietary nature. According to an exemplary embodiment, NF consumer device 205 and CHF 210 may each include logic of an exemplary embodiment of the service type-based policy counter service. For example, NF consumer device 205 and CHF 210 may each perform a function, an operation, and/or a service that is beyond a function and/or service associated with the network standard. The messages described and illustrated are exemplary.

Referring to FIG. 2A, NF consumer device 205 may obtain subscription information that indicates a decision depends on the status of a policy counter available at CHF 210. In response, NF consumer device 205 may generate a subscription request 215. According to an exemplary scenario, subscription request 215 may correspond to an initial spending limit report retrieval. According to another exemplary scenario, subscription request 215 may correspond to an intermediate spending limit report retrieval. In either case, subscription request 215 may include the policy counter type data, as described herein. For example, when NF consumer device 205 is implemented as an SM-PCF, the SM-PCF may be only interested in SM type policy counter(s). As such, the SM-PCF may generate subscription request 215 to include the policy counter type IE to indicate the SM policy counter type (e.g., PolicyCounterType=SM). According to another example, when NF consumer device 205 is implemented as an AM-PCF, the AM-PCF may be interested in both SM and AM types of policy counters. As such, the AM-PCF may generate subscription request 215 to include the policy counter type IE to indicate the AM and SM policy counter types (e.g., PolicyCounterType=SM, AM). In this regard, the policy counter type IE may include one or multiple policy counter types.

According to other examples, the policy counter type IE may include other policy indications. For example, an NF service consumer may wish to obtain all policy counters for one category of policies and only some policy counters pertaining to another category of policies. By way of further example, the policy counter type IE may indicate a category of policy counters and one or more policy counter identifiers associated with another category (e.g., PolicyCounterType=NEF, 1, 2, 3). As a part of the generation procedure of subscription request 215, NF consumer device 205 may perform a lookup of policy counter information.

FIG. 2B is a diagram illustrating exemplary policy counter information. For example, referring to a table 250 in FIG. 2B, exemplary policy counter information is illustrated. Table 250 may include a policy counter identifier field 255 and a policy counter type field 260. As further illustrated, table 250 includes entries 265-1 through 265-X (also referred as entries 265, or individually or generally as entry 265) that each includes a grouping of fields 255 and 260 that are correlated (e.g., a record, etc.). The policy counter information is illustrated in tabular form merely for the sake of description. In this regard, policy counter information may be implemented in a data structure different from a table (e.g., a list, a flat file, etc.), a database, or another type of structure. Additionally, values illustrated in field 255 and field 260 are exemplary. According to other embodiments, the values, strings, or instances of information stored in a field may be different. The number of entries 265 are exemplary for the sake of description purposes.

Policy counter identifier field 255 may store data that identifies a policy counter for a subscriber (e.g., end device 130, a user associated with end device 130, etc.).

Policy counter type field 260 may store a policy counter type. The policy counter type may indicate a type of policy counter for the correlated policy counter identifier indicated in field 255. For example, the policy counter type may include exemplary policy counter type values, such as session management (SM), access and mobility management (AM), UE, NEF, AMF, ALL (e.g., all policies associated with all categories or policy types) and/or another configurable policy counter type (e.g., all policies associated with a category and policy counter identifiers associated with another category), as described herein.

According to other exemplary embodiments, table 250 may store additional and/or different instances of policy counter information in support of the service type-based policy counter service and/or the spending limit control/reporting service, as described herein. For example, table 250 may include policy counter status information, activation times, NF consumer device subscription information, and so forth. According to another example, policy counter type may combine a superset category, which includes multiple categories. For example, instead of AM and SM policy counter types (e.g., PolicyCounterType=SM, AM) one could simply implement this with fewer instances of data, such as (e.g., PolicyCounterType=SA) in which SA=SM+AM. The superset policy counter type may be combined with a policy counter identifier another category not included in the categories of the superset depending on the total number of categories and the number of categories associated with the superset category.

Referring back to FIG. 2A, the generation of subscription request 215 may include other types of data, such as a subscription permanent identifier (SUPI), a notification correlation target address, and optionally other types of data, such as a general public subscription identifier (GPSI), subscription expiration time control data, and/or other types of data. NF consumer device 205 may transmit subscription request 215 to CHF 210 via an interface. As described herein, according to various exemplary embodiments, the interface may be a service-based interface, a reference point-based interface, an Open Radio Access Network (O-RAN) interface, or some other type of interface. According to an exemplary implementation, the interface may be implemented as a modified N28 interface, a modified Nchf interface, a modified spending limit control service interface, and/or the like, as described herein.

In response to receiving subscription request 215, CHF 210 may read and analyze subscription request 215, which includes reading and analyzing the policy counter type. CHF 210 may store policy counter information (e.g., table 250), as described herein. CHF 210 may perform a lookup of policy counter information, as described herein, regarding the indicated policy counter type. CHF 210 may create a new subscription resource, which may include a list of the policy counters to which the policy counter type pertains, assign a subscription identifier, and store a subscription resource. CHF 210 may generate and transmit a subscription response 220 to NF consumer device 205. Subscription response 220 may include policy counter status information for all corresponding policy counters pertaining to the policy counter type (or those currently available absent those that may be pending status information). Subscription response 220 may include other types of information (e.g., uniform resource indicator (URI) of the created subscription resource), a message body containing a representation of the created subscription, an expiry attribute, etc.

NF consumer device 205 may receive, read, and analyze subscription response 220, and determine and/or execute a policy decision based on the policy counter status information.

FIG. 2A illustrates exemplary process 200 of an exemplary embodiment of the service type-based policy counter service, according to other exemplary processes, different and/or additional processes or operations may be performed. For example, process 200 may include the generation and transmission of a message to NF consumer device 205 as a part of a spending limit control notify service (e.g., change of the status of a subscribed policy counter for the subscriber, provide one or more pending policy counter statuses, etc.).

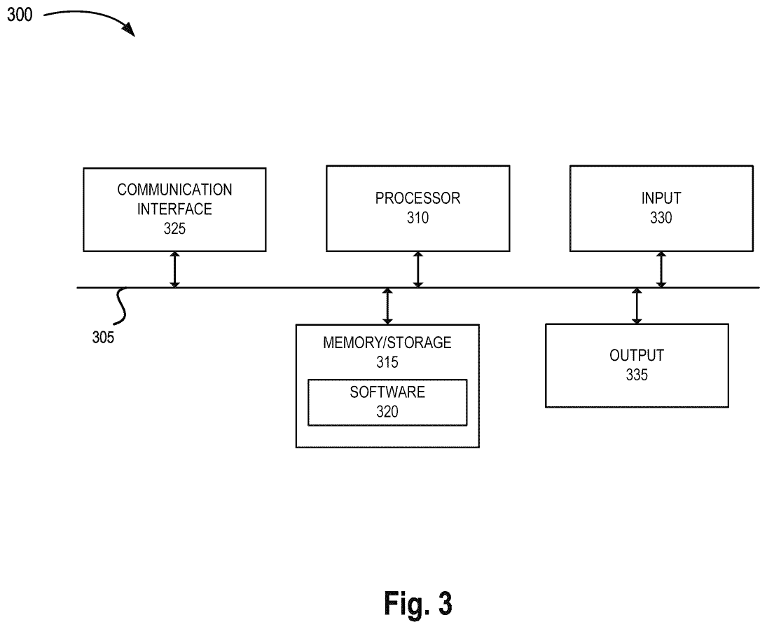

FIG. 3 is a diagram illustrating exemplary components of a device 300 that may be included in one or more of the devices described herein. For example, device 300 may correspond to access device 107, external device 117, core device 122, end device 130, NF consumer device 205, CHF 210, and/or other types of devices, as described herein. As illustrated in FIG. 3, device 300 includes a bus 305, a processor 310, a memory/storage 315 that stores software 320, a communication interface 325, an input 330, and an output 335. According to other embodiments, device 300 may include fewer components, additional components, different components, and/or a different arrangement of components than those illustrated in FIG. 3 and described herein.

Bus 305 includes a path that permits communication among the components of device 300. For example, bus 305 may include a system bus, an address bus, a data bus, and/or a control bus. Bus 305 may also include bus drivers, bus arbiters, bus interfaces, clocks, and so forth.

Processor 310 includes one or multiple processors, microprocessors, data processors, co-processors, graphics processing units (GPUs), application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, neural processing unit (NPUs), and/or some other type of component that interprets and/or executes instructions and/or data. Processor 310 may be implemented as hardware (e.g., a microprocessor, etc.), a combination of hardware and software (e.g., a SoC, an ASIC, etc.), may include one or multiple memories (e.g., cache, etc.), etc.

Processor 310 may control the overall operation, or a portion of operation(s) performed by device 300. Processor 310 may perform one or multiple operations based on an operating system and/or various applications or computer programs (e.g., software 320). Processor 310 may access instructions from memory/storage 315, from other components of device 300, and/or from a source external to device 300 (e.g., a network, another device, etc.). Processor 310 may perform an operation and/or a process based on various techniques including, for example, multithreading, parallel processing, pipelining, interleaving, learning, model-based, etc.

Memory/storage 315 includes one or multiple memories and/or one or multiple other types of storage mediums. For example, memory/storage 315 may include one or multiple types of memories, such as, a random access memory (RAM), a dynamic RAM (DRAM), a static RAM (SRAM), a cache, a read only memory (ROM), a programmable ROM (PROM), an erasable PROM (EPROM), an electrically EPROM (EEPROM), a single in-line memory module (SIMM), a dual in-line memory module (DIMM), a flash memory (e.g., 2D, 3D, NOR, NAND, etc.), a solid state memory, and/or some other type of memory. Memory/storage 315 may include a hard disk (e.g., a magnetic disk, an optical disk, a magneto-optic disk, a solid-state component, etc.), a Micro-Electromechanical System (MEMS)-based storage medium, and/or a nanotechnology-based storage medium.

Memory/storage 315 may be external to and/or removable from device 300, such as, for example, a Universal Serial Bus (USB) memory stick, a dongle, a hard disk, mass storage, off-line storage, or some other type of storing medium. Memory/storage 315 may store data, software, and/or instructions related to the operation of device 300.

Software 320 includes an application or a program that provides a function and/or a process. As an example, with reference to an NF consumer device (e.g., NF consumer device 205, etc.), software 320 may include an application that, when executed by processor 310, provides a function and/or a process of the service type-based policy counter service, as described herein. As another example, with reference to charging device (e.g., CHF 210, etc.), software 320 may include an application that, when executed by processor 310, provides a function and/or a process of the service type-based policy counter service, as described herein. Software 320 may also include firmware, middleware, microcode, hardware description language (HDL), and/or another form of instruction. Software 320 may also be virtualized. Software 320 may further include an operating system (e.g., Windows, Linux, Android, proprietary, etc.).

Communication interface 325 permits device 300 to communicate with other devices, networks, systems, and/or the like. Communication interface 325 includes one or multiple wireless interfaces, optical interfaces, and/or wired interfaces. For example, communication interface 325 may include one or multiple transmitters and receivers, or transceivers, an antenna, and the like. Communication interface 325 may operate according to a protocol stack and a communication standard.

Input 330 permits an input into device 300. For example, input 330 may include a keyboard, a mouse, a display, a touchscreen, a touchless screen, a button, a switch, an input port, speech recognition logic, and/or some other type of visual, auditory, tactile, affective, olfactory, etc., input component. Output 335 permits an output from device 300. For example, output 335 may include a speaker, a display, a touchscreen, a touchless screen, a light, an output port, and/or some other type of visual, auditory, tactile, etc., output component.

As previously described, a network device may be implemented according to various computing architectures (e.g., in a cloud, etc.) and according to various network architectures (e.g., a virtualized function, PaaS, etc.). Device 300 may be implemented in the same manner. For example, device 300 may be instantiated, created, deleted, or some other operational state during its life-cycle (e.g., refreshed, paused, suspended, rebooted, or another type of state or status), using well-known virtualization technologies. For example, access device 107, core device 122, external device 117, and/or another type of network device or end device 130, as described herein, may be a virtualized device.

Device 300 may be configured to perform a process and/or a function, as described herein, in response to processor 310 executing software 320 stored by memory/storage 315. By way of example, instructions may be read into memory/storage 315 from another memory/storage 315 (not shown) or read from another device (not shown) via communication interface 325. The instructions stored by memory/storage 315 may configure processor 310 to perform a function, an operation, or a process described herein. Alternatively, for example, according to other implementations, device 300 may be configured to perform a function, an operation, or a process described herein based on the execution of hardware (processor 310, etc.).

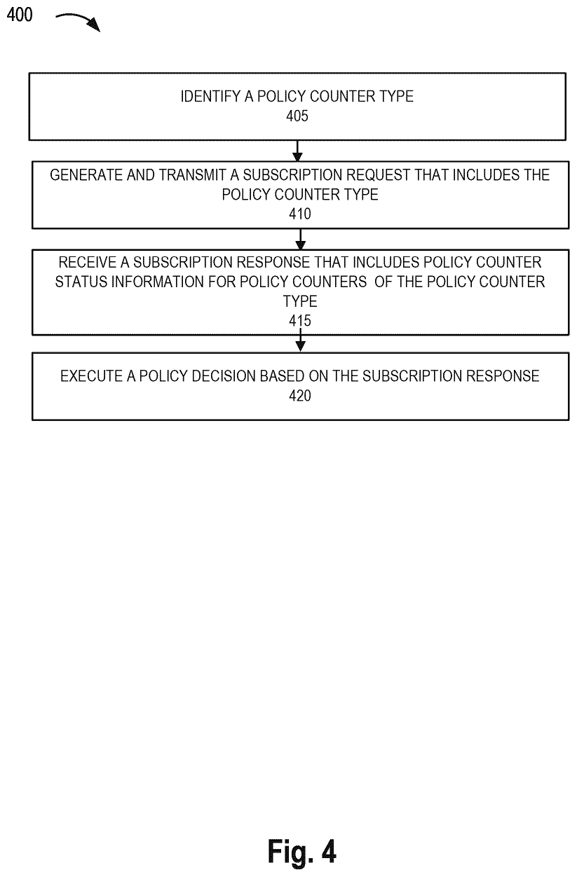

FIG. 4 is a flow diagram illustrating an exemplary process 400 of an exemplary embodiment of the service type-based policy counter service. According to an exemplary embodiment, an NF consumer device, such as a PCF, a split PCF, an AMF, or another type of NF consumer device, as described herein, may perform steps of process 400. According to an exemplary implementation, a processor may execute software to perform a step (in whole or in part) of process 400, as described herein. Alternatively, a step (in whole or in part) may be performed by execution of only hardware.

In block 405, an NF consumer device may identify a policy counter type. For example, the NF consumer device may determine that a policy decision depends on the status of policy counter status information associated with policy counters stored by a CHF. The NF consumer device may identify the policy counter type pertaining to the policy counters based on policy counter information, as described herein.

In block 410, the NF consumer device may generate and transmit a subscription request that includes the policy counter type. For example, the subscription request may include policy counter type data (e.g., an IE, an attribute value pair, etc.) that indicates a category of the policy counters of relevance. The NF consumer device may transmit the subscription request to the CHF or another type of charging device that provides a spending limit control service.

In block 415, the NF consumer device may receive a subscription response that includes policy counter status information for the policy counters of the policy counter type. For example, the subscription response may be received from the CHF or another type of charging device.

In block 420, the NF consumer device may execute a policy decision based on the subscription response. For example, the NF consumer device may use the policy counter status information associated with the policy counters of the policy counter type.

FIG. 4 illustrates an exemplary process 400 of the service type-based policy counter service, however, according to other exemplary embodiments, the service type-based policy counter service may perform additional operations, fewer operations, and/or different operations than those illustrated and described in relation to FIG. 4.

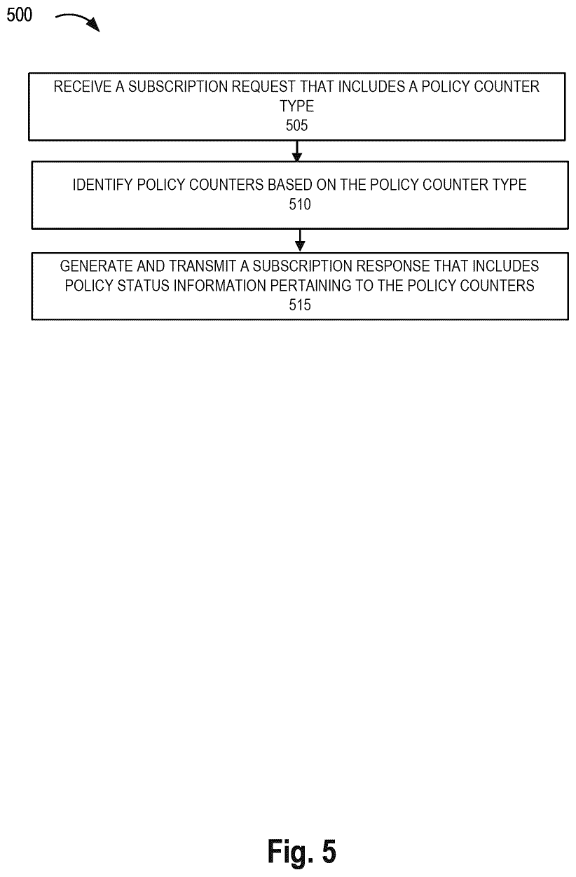

FIG. 5 is a flow diagram illustrating an exemplary process 500 of an exemplary embodiment of the service type-based policy counter service. According to an exemplary embodiment, a charging device, such as a CHF or another type of charging device, as described herein, may perform steps of process 500. According to an exemplary implementation, a processor may execute software to perform a step (in whole or in part) of process 500, as described herein. Alternatively, a step (in whole or in part) may be performed by execution of only hardware.

In block 505, a charging device may receive a subscription request that includes a policy counter type from an NF consumer device. For example, the subscription request may include policy counter type data (e.g., an IE, an attribute value pair, etc.) that indicates a category of the policy counters of relevance to which the NF consumer device wants to subscribe.

In block 510, the charging device may identify policy counters based on the policy counter type. For example, the charging device may identify the policy counters pertaining to the policy counter type based on policy counter information, as described herein.

In block 515, the charging device may generate and transmit a subscription response that includes policy status information pertaining to the policy counters of the policy counter type. The charging device may transmit the subscription response to the NF consumer device. The charging device may also create a subscription pertaining to the spending limit control service and other operations, as described herein.

FIG. 5 illustrates an exemplary process 500 of the service type-based policy counter service, however, according to other exemplary embodiments, the service type-based policy counter service may perform additional operations, fewer operations, and/or different operations than those illustrated and described in relation to FIG. 5.

As set forth in this description and illustrated by the drawings, reference is made to “an exemplary embodiment,” “exemplary embodiments,” “an embodiment,” “embodiments,” etc., which may include a particular feature, structure, or characteristic in connection with an embodiment(s). However, the use of the phrase or term “an embodiment,” “embodiments,” etc., in various places in the description does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The foregoing description of embodiments provides illustration but is not intended to be exhaustive or to limit the embodiments to the precise form disclosed. Accordingly, modifications to the embodiments described herein may be possible. For example, various modifications and changes may be made thereto, and additional embodiments may be implemented, without departing from the broader scope of the invention as set forth in the claims that follow. The description and drawings are accordingly to be regarded as illustrative rather than restrictive.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example.” Any embodiment or implementation described as “exemplary” is not necessarily to be construed as preferred or advantageous over other embodiments or implementations.

In addition, while series of blocks have been described regarding the processes illustrated in FIGS. 4 and 5, the order of the blocks may be modified according to other embodiments. Further, non-dependent blocks may be performed in parallel. Additionally, other processes described in this description may be modified and/or non-dependent operations may be performed in parallel.

Embodiments described herein may be implemented in many different forms of software executed by hardware. For example, a process or a function may be implemented as “logic,” a “component,” or an “element.” The logic, the component, or the element, may include, for example, hardware (e.g., processor 310, etc.), or a combination of hardware and software (e.g., software 320).

Embodiments have been described without reference to the specific software code because the software code can be designed to implement the embodiments based on the description herein and commercially available software design environments and/or languages. For example, diverse types of programming languages including, for example, a compiled language, an interpreted language, a declarative language, or a procedural language may be implemented.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processor 310) of a device. A non-transitory storage medium includes one or more of the storage mediums described in relation to memory/storage 315. The non-transitory computer-readable storage medium may be implemented in a centralized, distributed, or logical division that may include a single physical memory device or multiple physical memory devices spread across one or multiple network devices.

To the extent the aforementioned embodiments collect, store, or employ personal information of individuals, it should be understood that such information shall be collected, stored, and used in accordance with all applicable laws concerning protection of personal information. Additionally, the collection, storage and use of such information can be subject to the consent of the individual to such activity, for example, through well known “opt-in” or “opt-out” processes as can be appropriate for the situation and type of information. Collection, storage, and use of personal information can be in an appropriately secure manner reflective of the type of information, for example, through various encryption and anonymization techniques for particularly sensitive information.

No element, act, or instruction set forth in this description should be construed as critical or essential to the embodiments described herein unless explicitly indicated as such.

All structural and functional equivalents to the elements of the various aspects set forth in this disclosure that are known or later come to be known are expressly incorporated herein by reference and are intended to be encompassed by the claims.

What is claimed is:

1. A method comprising:
identifying, by a network device, a policy counter type that indicates a category of policy counters;
generating, by the network device, a subscription request, which includes the policy counter type;
transmitting, by the network device to a charging device, the subscription request;
receiving, by the network device, a subscription response that includes policy counter status information for the policy counters of the policy counter type; and
executing, by the network device, a policy decision based on the subscription response.

2. The method of claim 1, wherein the subscription request includes a subscription permanent identifier pertaining to a user or an end device.

3. The method of claim 1, wherein the policy counter type includes multiple policy counter types.

4. The method of claim 1, wherein the subscription request pertains to an initial spending limit retrieval associated with a spending limit control service of the charging device.

5. The method of claim 1, wherein the charging device is a Fifth Generation (5G) charging function (CHF).

6. The method of claim 1, further comprising:
storing, by the network device, policy counter information that includes policy counter identifiers and the policy counter type, which correlates to the policy counter identifiers, and wherein the identifying comprises:
identifying, by the network device, the policy counter type based on the policy counter information.

7. The method of claim 1, wherein the category includes at least one of session management, access and mobility management, or user equipment.

8. The method of claim 1, wherein the network device includes a policy control function (PCF) or a split PCF.

9. A network device comprising:
a processor, wherein the processor is configured to:
identify a policy counter type that indicates a category of policy counters;
generate a subscription request, which includes the policy counter type;
transmit to a charging device, the subscription request;
receive a subscription response that includes policy counter status information for the policy counters of the policy counter type; and
execute a policy decision based on the subscription response.

10. The network device of claim 9, wherein the subscription request includes a subscription permanent identifier pertaining to a user or an end device.

11. The network device of claim 9, wherein the policy counter type includes multiple policy counter types.

12. The network device of claim 9, wherein the subscription request pertains to an initial spending limit retrieval associated with a spending limit control service of the charging device.

13. The network device of claim 9, wherein the charging device is a Fifth Generation (5G) charging function (CHF).

14. The network device of claim 9, wherein the processor is further configured to:
store policy counter information that includes policy counter identifiers and the policy counter type, which correlates to the policy counter identifiers, and wherein, to identify, the processor is further configured to:
identify the policy counter type based on the policy counter information.

15. The network device of claim 9, wherein the category includes at least one of session management, access and mobility management, or user equipment.

16. The network device of claim 9, wherein the network device includes a policy control function (PCF) or a split PCF.

17. A non-transitory computer-readable storage medium storing instructions executable by a processor of a network device, wherein the instructions are configured to:
identify a policy counter type that indicates a category of policy counters;
generate a subscription request, which includes the policy counter type;
transmit to a charging device, the subscription request;
receive a subscription response that includes policy counter status information for the policy counters of the policy counter type; and
execute a policy decision based on the subscription response.

18. The non-transitory computer-readable storage medium of claim 17, wherein the subscription request pertains to an initial spending limit retrieval associated with a spending limit control service of the charging device.

19. The non-transitory computer-readable storage medium of claim 17, wherein the instructions are further configured to:
store policy counter information that includes policy counter identifiers and the policy counter type, which correlates to the policy counter identifiers, and wherein the instructions to identify are further configured to:
identify the policy counter type based on the policy counter information.

20. The non-transitory computer-readable storage medium of claim 17, wherein the category includes at least one of session management, access and mobility management, or user equipment.
